(19) United States
(12) Patent Application Publication
(10) Pub. No.: US 2013/0191787 A1
(43) Pub. Date: Jul. 25, 2013

(54) Systems and Methods for Acceleration-Based Motion Control of Virtual Tour Applications

(71) Applicant: TourWrist, Inc., San Francisco, CA (US)

(72) Inventors: Charles Robert Armstrong, San Francisco, CA (US); Brian Durwood Foshee, Coral Gables, FL (US)

(73) Assignee: TOURWRIST, INC., San Francisco, CA (US)

(21) Appl. No.: 13/733,908

(22) Filed: Jan. 4, 2013

Related U.S. Application Data
(60) Provisional application No. 61/584,183, filed on Jan. 6, 2012.

(51) Int. Cl. G06F 3/0481

(52) U.S. Cl. CPC G06F 3/04815
USPC 715/850

(57) ABSTRACT

The present invention relates to systems and methods for reliably detecting motion control of mobile devices to navigate virtual tour applications. In one embodiment, a computerized hand-held mobile device is configured to telespot from a first virtual tour environment to a second virtual tour environment upon detection of an intentional user motion, such as a flick, using a motion sensor. Upon detection of a potentially telespotting motion that is greater than a threshold and a viewing field of the mobile device substantially overlapping with an annotated link of the virtual tour, the mobile device telespots from the first virtual tour environment of the virtual tour to the second virtual tour environment of the virtual tour.

### CROSS REFERENCE TO RELATED APPLICATIONS

This non-provisional application claims the benefit of provisional application No. 61/584,183 filed on Jan. 6, 2012, entitled “Systems and Methods for Acceleration-Based Motion Control of Virtual Tour Applications”, which application is incorporated herein in its entirety by this reference.

### BACKGROUND

The present invention relates to systems and methods for detecting specific motions of mobile devices so as to interpret a user's desire to move about a virtual tour environment and/or to move from one virtual tour environment to another virtual tour environment.

Many mobile devices, including computer tablets and smart phones, are capable of measuring their respective rotation around the user, enabling virtual tours environments which are presented on the screens of these mobile devices to be panned by physically rotating these hand-held mobile devices along an imaginary circular track surrounding the user.

Based on these intuitive controls, users may have largely unfulfilled expectations whereby, for example, other physical movements of these mobile devices, e.g., sustained forward and backward translational movements may affect the placements within the virtual tour environments. Further, in many viewing circumstances, such physical control methods can be handicapped by a user's physical inability to move freely about their immediate surroundings, e.g., when the user is viewing a virtual tour while comfortably seated in an armchair.

It is therefore apparent that an urgent need exists for motion control systems and methods which empower users to fully navigate within virtual tour environment(s), regardless of the users' ability to physically move in any direction within a wide variety of users' real-life restrictive environment(s).

### SUMMARY

To achieve the foregoing and in accordance with the present invention, systems and methods for motion control detection is provided. In particular, these systems and methods detect intentional translational acceleration and abrupt rotation (flicking) of mobile devices executing virtual tour applications.

In one embodiment, a computerized hand-held mobile device is configured to telespot from a first virtual tour environment to a second virtual tour environment upon detection of an intentional user motion such as a flick. The mobile device includes at least one motion sensor, a processor and a display.

The at least one motion sensor is configured to detect a potentially telespotting motion of a mobile device configured to conduct a virtual tour for a user. The processor is configured to determine if a magnitude of the potentially telespotting motion is greater than a threshold and to detect if a viewing field of the mobile device substantially overlaps with an annotated link of the virtual tour. The display is configured to display a first virtual tour environment of the virtual tour.

If the magnitude of the potentially telespotting motion is greater than the threshold and the substantial overlap of the viewing field has been detected, then the display telespots from the first virtual tour environment of the virtual tour to a second virtual tour environment of the virtual tour. Conversely, if the magnitude of the potentially telespotting motion is determined to be greater than the threshold but no substantial overlap of the viewing field has been detected, then the display telescopes the viewing field of the display along a substantially lateral axis of the mobile device.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a perspective view of a mobile device which uses accelerometer and/or gyroscopic values to determine motion change(s) of the mobile device caused by a user in accordance with one embodiment of the present invention;

FIG. 2 is a perspective view of the mobile device of FIG. 1, illustrating the relationship between what is shown onscreen, and the virtual tour the user is controlling. FIG. 2 also illustrates a technique whereby the mobile device can be accelerated along any combination of the X/Y, X/Z and Y/Z planes to telescope the user's view of a virtual tour environment;

FIG. 3 is a perspective view of the mobile device of FIG. 1 which may be quickly rotated along the X-Axis to flick the mobile device forward or backward;

FIG. 4 illustrates a virtual tour environment including one or more annotated link(s) to, for example, another virtual tour environment, for the mobile device of FIG. 1; and

FIGS. 5 and 6 are flow diagrams illustrating evaluation of motion change(s) in the mobile device of FIG. 1 to determine the user's navigational intention(s).

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

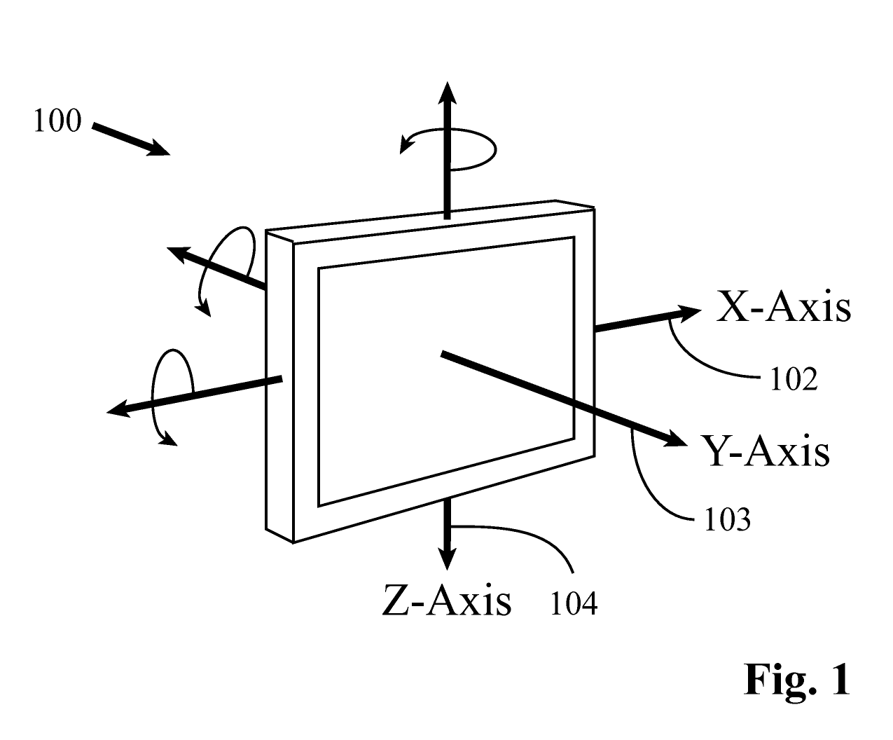

The present invention relates to systems and methods for reliably detecting motion control of mobile devices executing virtual tour (herein after also referred to as “VT”) applications. Note that the term mobile device is intended to include all portable electronic devices including cellular phones, computerized tablets, cameras, and hand-held gaming devices. To facilitate discussion, FIG. 1 shows perspective view of a mobile device 100 which utilizes accelerometer values to determine angular rotation of the device in accordance with one embodiment of the present invention.

In this embodiment, mobile device 100 includes an accelerometer and/or gyroscope (not shown) for measuring the angular rotations along the X-Axis 102, Y-Axis 103, and Z-Axis 104.

Suitable accelerometers and gyroscopes for mobile device 100 are commercially available from a variety of manufacturers including ST Electronics Ltd of Berkshire, United Kingdom, AKM Semiconductor Inc. of San Jose, Calif., and InvenSense Inc. of Sunnyvale, Calif.

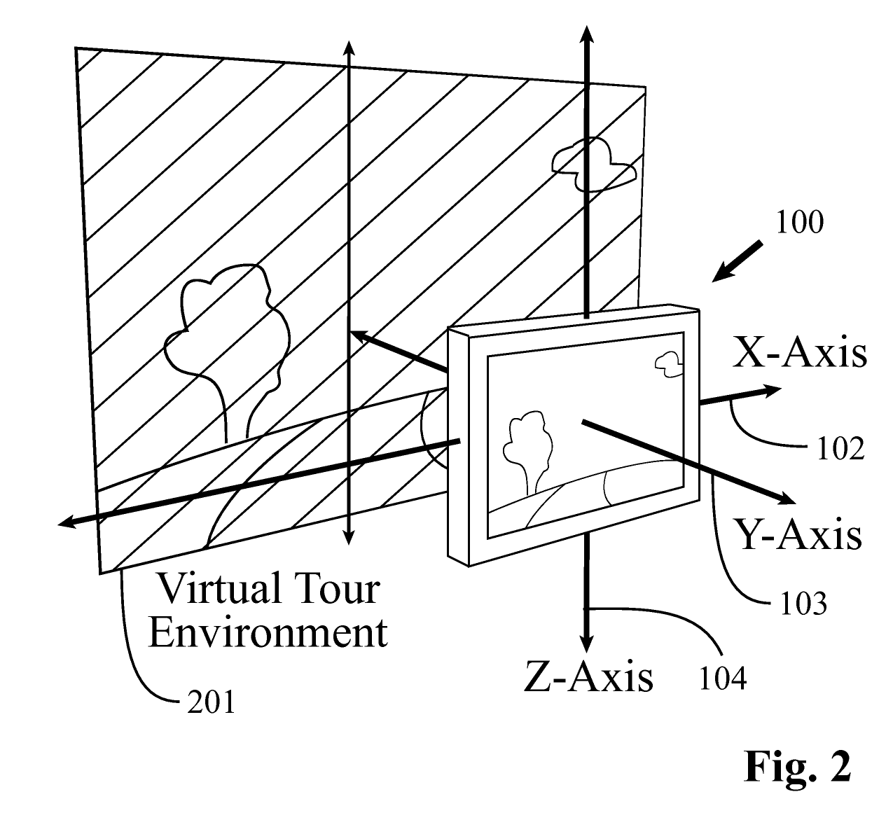

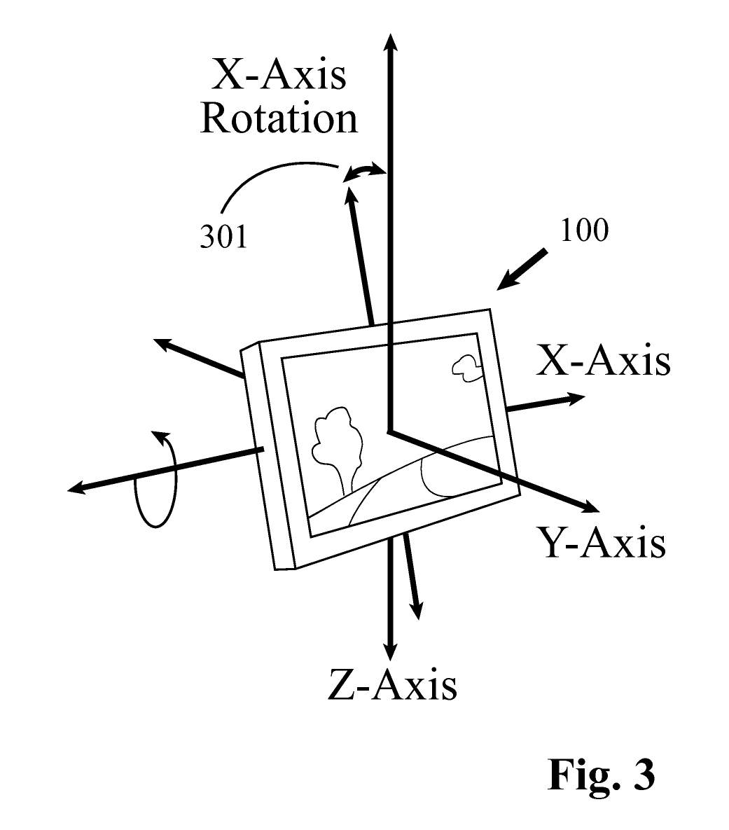

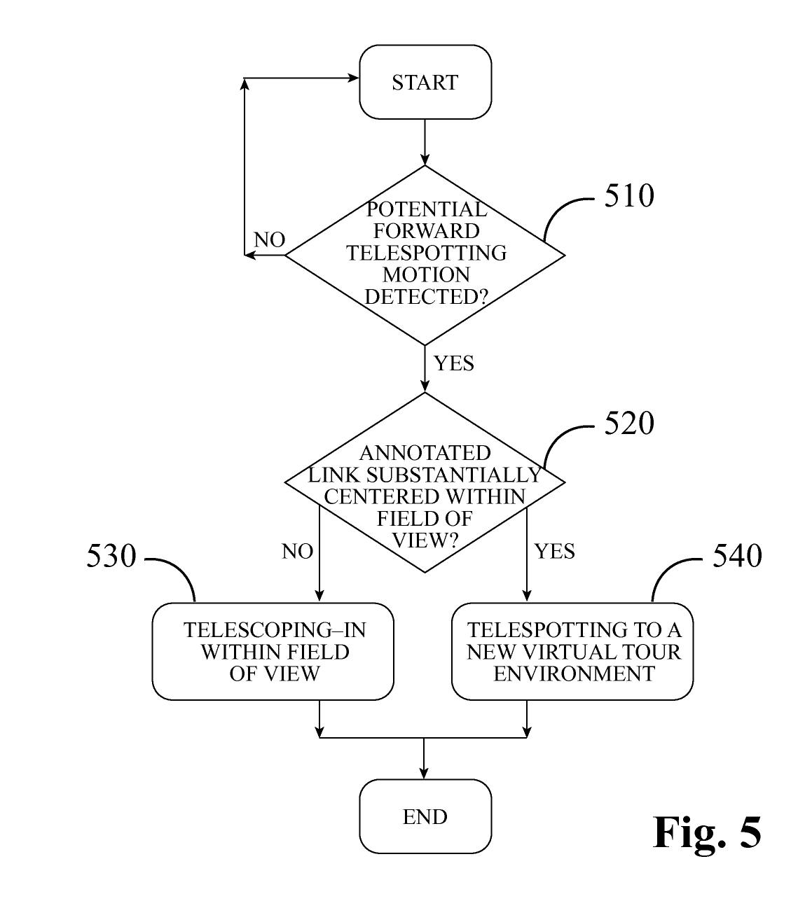

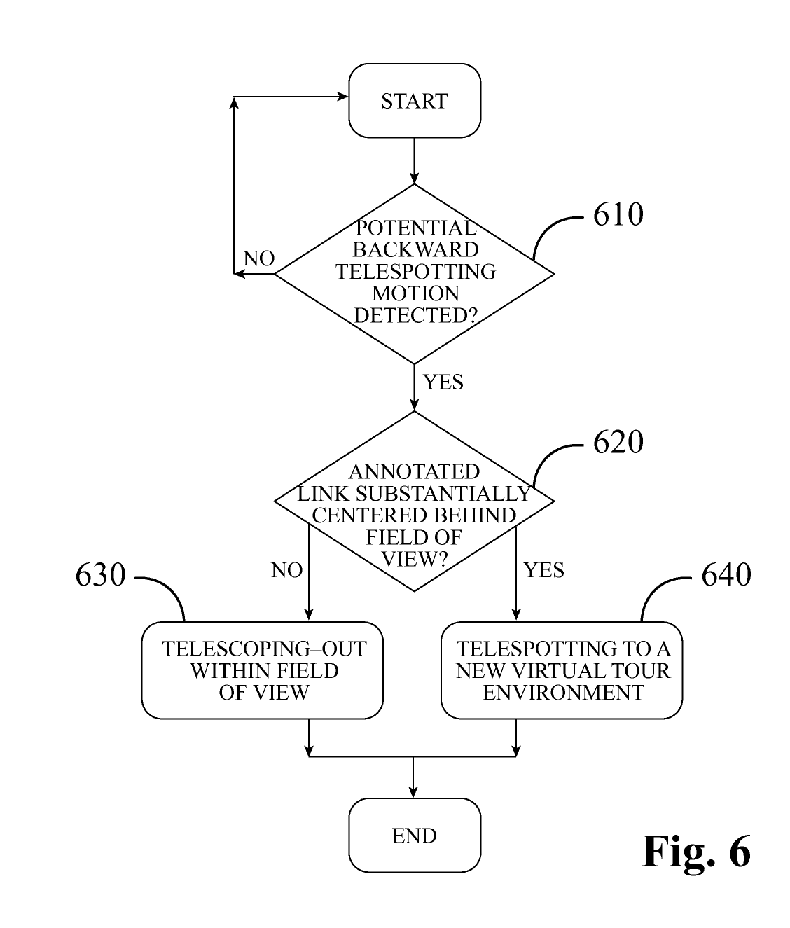

As illustrated by exemplary perspective views of FIGS. 2 to 4 and by exemplary flow diagrams of FIGS. 5 and 6 in some embodiments, in order to enable a user's hand-holding mobile device 100 to navigate within a virtual tour environment 201 without the need to use touch-screen or physical buttons of mobile device 100, translational and/or angular acceleration may be measured using, for example, the mobile device 100's accelerometer and/or gyroscope. Note that FIG. 2 illustrates translational acceleration in the Y-Axis, while FIG. 3 illustrates angular (also referred to as rotational) acceleration in the X-Axis.

In one embodiment, as exemplified by FIG. 5, the flow diagram illustrates a telespotting/telescoping motion control in the forward direction. In this example, upon detection of a potential forward telespotting motion (step 510), depending on whether an annotated link, e.g., a hotspot, is substantially centered within a field of view of mobile device 100 (step 520), a potentially telespotting motion can be interpreted as a user intent to telespot to, for example, another VT environment (step 540), or an intent to telescope-in within the field of view of the mobile device 100 (step 530). Conversely, as exemplified also by FIG. 6, the flow diagram illustrates a telespotting/telescoping motion control in the backward direction. In this example, upon detection of a potential backward telespotting motion (step 610), depending on whether the annotated link is substantially centered behind a field of view of mobile device 100 (step 620), a potentially telespotting motion can be interpreted as a user intent to telespot to, for example, yet another VT environment (step 640), or an intent to telescope-out within the field of view of the mobile device 100 (step 630). Note that in this embodiment, potential telespotting motions include flicking and telescoping, associated with angular acceleration and planer acceleration, respectively.

For example, angular acceleration illustrated by FIG. 3 can be used as a motion control of mobile device 100, namely, quick X-Axis rotation 301 to flick mobile device 100 forward or backward. This somewhat abrupt rotation 301 may be performed in a short, finite period of time to better discern the user's desire to flick mobile device 100, rather than a relatively slower rotation intended to change the viewing angle. This technique is represented in steps 510, 540 and 610, 640, respectively, in flow diagrams of FIG. 5 and FIG. 6.

To successfully register a valid forward flick, mobile device 100 should for example achieve between approximately 20° to approximately 45° in relative X-Axis rotation 301 within approximately 500 milliseconds. Conversely, to successfully register a backward flick, mobile device 100 should for example achieve between approximately −20° to approximately −45° in relative X-Axis rotation 301 within approximately 500 milliseconds.

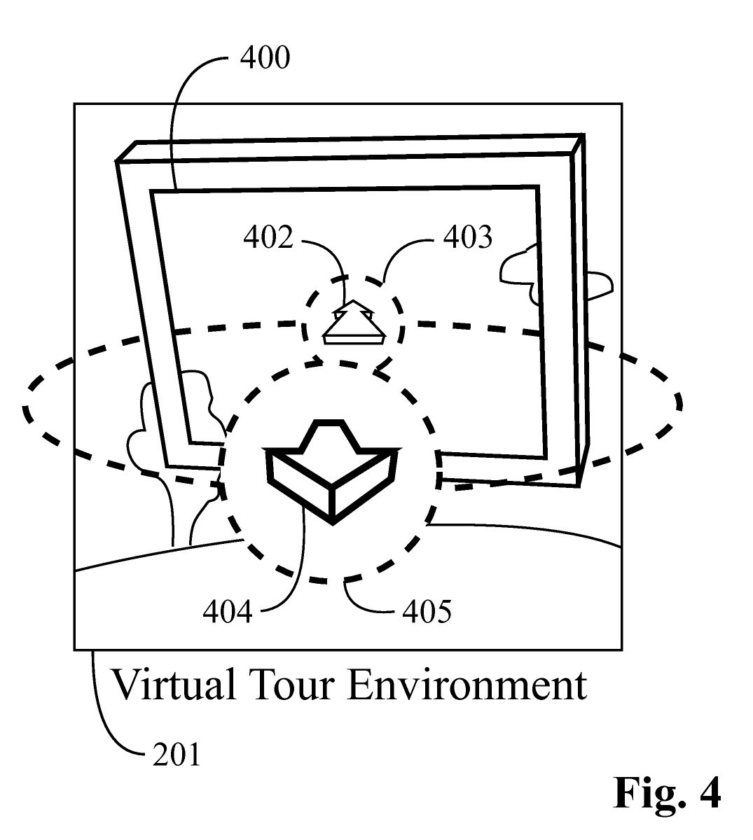

Further, as illustrated in FIGS. 4 and 5, in some embodiments, an onscreen annotated link 402 to another VT environment is deemed sufficiently centered 403 when within approximately 5 degrees (vertically and horizontally) of the current field of view 400. This is also conveyed in the FIG. 5 flowchart (step 520). When this is true, onscreen annotated link 402 may optionally highlight to indicate that it is capable of being activated by motion controls of mobile device 100. Hence, when onscreen annotated link 402 is centered (vertically and horizontally) of the current field of view 400 and a forward telespotting motion is recognized, the linked VT environment may be loaded (step 540). As a result, when a forward flick is properly executed on mobile device 100, the user should be able to successfully telespot forward to annotated link 402.

Conversely, as illustrated by FIGS. 4 and 6, an off-screen annotated link 404 to another VT environment is deemed sufficiently centered 405 when within approximately 10 degrees (vertically and horizontally) substantially opposite to the (forward) center 403 of the current field of view 400. This is also conveyed in the FIG. 6 flowchart (620). Accordingly, when off-screen annotated link 404 is centered and a backward telespotting motion is recognized, the corresponding linked VT environment may be loaded (step 640), and the user should be able to successfully telespot back to annotated link 404.

It is contemplated that annotated links may direct to a wide variety of media or features, such as hotspots to other VT environments, online advertisements, images, videos, audio, web pages, notes and special controls.

For example, while virtual touring a cruise ship, the user may telespot to a VT such as a scuba dive of a coral reef, or while virtual touring a hotel suite in Africa, the user may telespot down the hallway, telespot to a photograph on the wall, to a night safari VT or open a menu on the table for a VT of the resort restaurant or spa, or while virtual touring a Singapore Airlines premier class section, the user may telespot to Book-a-Cook™ to order a personalized gourmet meal or VT a storefront to select an anniversary gift for a spouse.

Referring back to FIG. 2, in some embodiments, in order to enable the user to freely navigate the virtual tour and change the viewing position(s) of mobile device 100 within virtual tour environment 201 (along exemplary X/Y, X/Z, and/or Y/Z planes) without the need to use touch-screen or physical buttons of mobile device 100, translational acceleration may be measured, using for example the mobile device 100's accelerometer, so as to cause the viewing position within a virtual tour environment presented via mobile device 100 to telescope in a corresponding direction. This technique is also illustrated in the flow diagrams of FIGS. 5 and 6 (510, 530 and 610, 630) and discussed in greater detail below.

To successfully register a valid forward telescoping motion (also referred to as a telezoom motion), mobile device 100 should for example achieve substantial translational acceleration along Y-Axis 103. When properly executed, viewing position of mobile device 100 within onscreen VT environment 201 should appear to telescope forward along the Y-Axis 103 (toward VT environment 201). Conversely, to successfully register a backward telescoping motion, mobile device 100 should for example achieve substantial translational acceleration along Y-Axis 103, thereby causing viewing position of mobile device 100 within VT environment 201 appears to telescope backward along the Y-Axis 103.

Telescoping of mobile device 100 along other planes is also possible as shown in FIG. 2. For example, as X-Axis 102 readings from the mobile device 100's accelerometer increases or decreases substantially, viewing position of mobile device 100 within onscreen VT environment 201 can appear to telescope toward, for example, the right or left of the user. Similarly, as Z-Axis 104 readings from the accelerometer of mobile device 100 increases or decreases substantially, viewing position of mobile device 100 within onscreen VT environment 201 to telescope up or down relative to the user.

Accordingly, with this navigational freedom provided by mobile device 100, the user should also be able to virtually and seamlessly travel with ease along hallways, to jump up for a higher viewpoint or crouch down, to move up or down escalators, stairways, elevators, in and out of doorways, and any other viewing positional transitions, within the VT environment(s).

It should be appreciated that many variations of motion control recognition strategies are also possible with the scope of the present invention. In one implementation, only forward flicking motions and backward flicking motions are recognized as valid intent to telespot by mobile device 100. In another implementation, only forward telescoping motions and backward telescoping motions are recognized as valid intent telescope by mobile device 100. In yet another implementation, two or more sequential flicks of the mobile device 100 are recognized as additional user's navigational intentions to, for example, multiple telespotting or some other different navigational intention.

Further, many aiming aids and combinations thereof for centering annotated link(s) to accomplish telespotting are also contemplated, including highlights, modification of chrominance and/or luminance, target sights such as cross hairs, modification of focal point(s), and spot magnification.

In sum, the present invention provides systems and methods for detecting translational acceleration across X/Y, X/Z and Y/Z planes, and forward or backward flicking of mobile devices executing virtual tour applications. The goal is to reliably interpret a user's desire to move forward or backward and to move to adjacent virtual tour environments, if available. Advantages include intuitive translation of tactile controls to motion controls, and the ability to enable visceral navigation experience in the user's spatially-limited physical environments.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for telespotting from a first virtual tour environment to a second virtual tour environment, the method useful in association with a mobile device configured to be hand-held by a user, the telespotting method comprising:
detecting a telespotting motion of a mobile device configured to conduct a virtual tour for a user;
evaluating a magnitude of the telespotting motion; and
if the magnitude of the telespotting motion is greater than a threshold, then telespotting from a first virtual tour environment of the virtual tour to a second virtual tour environment of the virtual tour.

2. The telespotting method of claim 1 further comprising detecting if a viewing field of the mobile device substantially centered with respect to an annotated link of the virtual tour.

3. The telespotting method of claim 2 wherein the annotated link is embedded in the first virtual tour environment of the virtual tour.

4. The telespotting method of claim 1 wherein the telespotting motion includes a flick.

5. The telespotting method of claim 1 wherein the telespotting motion includes acceleration along a substantially lateral axis of the mobile device.

6. The telespotting method of claim 1 wherein the threshold is user adjustable.

7. The telespotting method of claim 1 wherein the threshold can be dynamically adjusted.

8. The telespotting method of claim 1 further comprising determining if the telespotting motion is forward.

9. The telespotting method of claim 2 further comprising determining if the telespotting motion is forward and if the annotated link is in front of the viewing field.

10. The telespotting method of claim 1 further comprising determining if the telespotting motion is backward.

11. The telespotting method of claim 2 further comprising determining if the telespotting motion is backward and if the annotated link is behind the viewing field.

12. A computerized method for potentially telespotting from a first virtual tour environment to a second virtual tour environment, the method useful in association with a mobile device configured to be hand-held by a user, the potentially telespotting method comprising:
detecting a potentially telespotting motion of a mobile device configured to conduct a virtual tour for a user;
evaluating a magnitude of the potentially telespotting motion; and
if the magnitude of the potential telespotting motion is greater than a threshold, then detecting if a viewing field of the mobile device substantially centered with respect to an annotated link of the virtual tour; and
if the viewing field is substantially centered with respect to the annotated link, then telespotting from a first virtual tour environment of the virtual tour to a second virtual tour environment of the virtual tour;
else if the viewing field is not substantially centered with respect to the annotated link, then telescoping the viewing field along a substantially lateral axis of the mobile device.

13. The potentially telespotting method of claim 12 wherein the annotated link is embedded in the first virtual tour environment of the virtual tour.

14. The potentially telespotting method of claim 12 wherein the potentially telespotting motion includes a flick.

15. The potentially telespotting method of claim 12 wherein the potentially telespotting motion includes acceleration along the substantially lateral axis of the mobile device.

16. The potentially telespotting method of claim 12 further comprising determining if the potentially telespotting motion is forward and if the viewing field is substantially centered with the annotated link located in front of the viewing field of the mobile device.

17. The potentially telespotting method of claim 12 further comprising determining if the potentially telespotting motion is backward if the viewing field is substantially centered with the annotated link located behind the viewing field of the mobile device.

18. The potentially telespotting method of claim 12 further comprising determining if the potentially telespotting motion is forward, and if the telespotting motion is forward and the viewing field is not substantially centered then the viewing field of the mobile device is telescoped along the substantially lateral axis of the mobile device in a forward direction.

19. The potentially telespotting method of claim 12 further comprising determining if the potentially telespotting motion is backward, and if the telespotting motion is forward then the viewing field of the mobile device is telescoped along the substantially lateral axis of the mobile device in a backward direction.

20. The potentially telespotting method of claim 12 wherein the threshold is user adjustable.

21. The potentially telespotting method of claim 12 wherein the threshold can be dynamically adjusted.

22. A computerized method for telescoping a viewing field of a mobile device, the method useful in association with the mobile device configured to be hand-held by a user, the telescoping method comprising:
detecting a telescoping motion along a substantially lateral axis of a mobile device configured to conduct a virtual tour for a user;
evaluating a magnitude of the advancing motion; and
if the magnitude of the telescoping motion is greater than a given threshold, then telescoping a viewing field of the mobile device along a substantially lateral axis of the mobile device.

23. The telescoping method of claim 22 wherein the telescoping motion includes acceleration along a substantially lateral axis of the mobile device.

24. The telescoping method of claim 22 wherein the threshold is adjustable.

25. The telescoping method of claim 22 further comprising determining if the telescoping motion is forward, and if the telescoping motion is determined to be forward, then telescoping the viewing field of the mobile device along the substantially lateral axis of the mobile device in a forward direction.

26. The telescoping method of claim 22 further comprising determining if the telescoping motion is backward, and if the telescoping motion is determined to be backward, then telescoping the viewing field of the mobile device along the substantially lateral axis of the mobile device in a backward direction.

27. The telescoping method of claim 22 wherein the telescoping motion includes a flick.
